(19) United States
(12) Patent Application Publication
(10) Pub. No.: US 2009/0124344 A1
(43) Pub. Date: May 14, 2009

(54) Reconfigurable Gaming Machine

(75) Inventors: Michael Mitchell, Las Vegas, NV (US); David Schultz, Henderson, NV (US); Alexander Villagran, Las Vegas, NV (US); Keith Lange, Henderson, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/258,752

(22) Filed: Oct. 27, 2008

Related U.S. Application Data
(60) Provisional application No. 60/986,850, filed on Nov. 9, 2007.

(51) Int. Cl. A63F 9/24; A63F 13/00

(52) U.S. Cl. 463/20

(57) ABSTRACT

Disclosed are reconfigurable gaming machines, networked gaming systems and methods for gaming machine reconfiguration.

### RELATED APPLICATIONS

This application claims priority from U.S. provisional patent application 60/986,850 filed on Nov. 9, 2007, hereby incorporated by reference in its entirety for all purposes.

This application is also related to U.S. patent application Ser. No. ______ entitled “RECONFIGURABLE GAMING MACHINE METHOD,” filed on Oct. ______, 2008 which claims priority from provisional application 60/986,850 filed on Nov. 9, 2007.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to gaming machines and methods and, more particularly, to gaming machines and methods having a reconfiguration scheduler.

2. Description of the Related Art

Today's gaming machines have parameters programmed into their code such as theme, percentage, denomination, maximum lines bet, minimum bet, maximum bet, game run time, and the like. In some cases, changing any of these parameters requires new game code, regulatory approval for the code changes, physical movement of machines weighing hundreds of pounds and regulatory approval for the move and oversight. In other cases, option settings in the machine may be manually changed by a technician or other gaming establishment employee.

Furthermore, gaming machines have operated for the most part as stand-alone devices, at least with respect to non-progressive gaming. In this regard, while there may have existed some limited forms of communication or networking, fully-networked data and communication systems have not been traditionally implemented. One reason for this lack of fully-networked infrastructure is the difficulty in upgrading system infrastructure, due to the constant utilization of a gaming system, 24 hours a day, 7 days a week, 365 days a year. For this reason and others, gaming machines have typically been utilized as separate machines, which are swapped out or upgraded, but which generally operate autonomously.

While it would be desirable for gaming machines to be utilized as components of a larger interactive and symphonious organizational arrangement, many obstacles have made such an arrangement difficult and unwieldy to visualize, let alone implement. The lack of such a system deprives casino owners of both apparent and actual control over their gaming floors.

Further, casino patrons are limited in the variety and selection of both games, and the gaming parameters within such games, that are available to them. These limitations are commonly due to the particularized nature and general lack of customization typically associated with individual gaming machines. In this regard, casino owners have become aware that by adding additional features to gaming machines, they may be able to maintain a player's attention to the gaming machines for longer periods of time. This, in turn, leads to the player wagering at the gaming machine for longer periods of time, thereby increasing casino profits.

Ideally, the casino owner would be able to rapidly tailor changes to gaming machine features according to yield management data, traffic patterns within the casino at various times of the week, on holidays, etc. Accordingly, there exists a continuing need for improved gaming machine reconfiguration.

### SUMMARY OF THE INVENTION

In accordance with one or more embodiments of the invention, a reconfigurable gaming machine includes a processor and a memory operatively coupled to the processor, the memory storing a set of preset configurations for the gaming machine. A scheduler is operable by the processor to activate one of the set of configurations according to conditions associated with the activated configuration.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of a gaming machine in accordance with one or more aspects of the present invention.

FIG. 2 is a block diagram of the physical and logical components of an example motherboard of the gaming machine of FIG. 1.

FIG. 3 is a display image associated with an example reconfiguration screen in accordance with one or more embodiments of the invention.

FIG. 4 is a functional block diagram depicting the steps associated with carrying out an example method in accordance with one or more aspects of the invention.

FIG. 5 is a display image associated with an example reconfiguration screen in accordance with one or more embodiments of the invention.

FIG. 6 is a functional block diagram depicting the steps associated with carrying out an example method in accordance with one or more aspects of the invention.

FIG. 7 is a display image associated with an example game in accordance with one or more embodiments of the invention.

FIG. 8 is a display image associated with an example pay table in accordance with one or more embodiments of the invention.

FIG. 9 is a display image associated with an example selection screen in accordance with one or more embodiments of the invention.

FIG. 10 is a schematic block diagram showing the hardware elements of a networked gaming system in accordance with one aspect of the present invention.

### DETAILED DESCRIPTION OF THE PREFERRED EMBODIMENTS

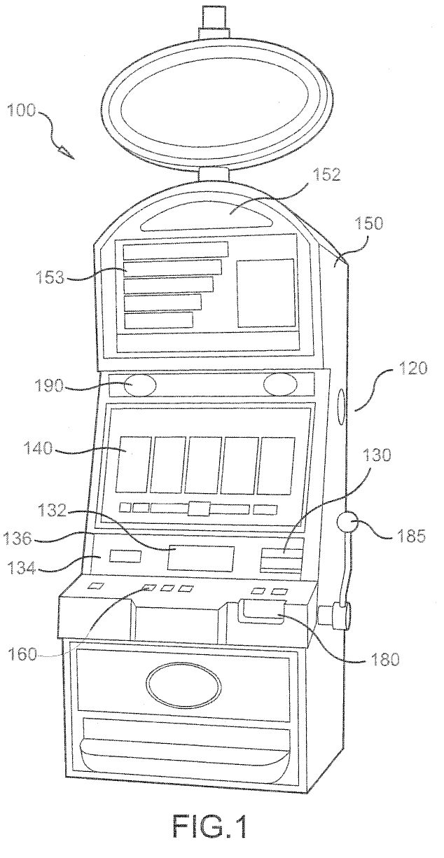

Various embodiments are directed to reconfigurable gaming machines and methods for reconfiguring gaming machines. Embodiments of one or more gaming machines and methods are illustrated and described herein, by way of example only, and not by way of limitation. Referring now to the drawings, and more particularly to FIGS. 1-10, there are shown illustrative examples of one or more reconfigurable gaming machines and methods for reconfiguring gaming machines in accordance with various aspects of the invention.

In accordance with one or more embodiments, FIG. 1 illustrates an example reconfigurable gaming machine 100. Gaming machine 100 includes cabinet housing 120, primary game display 140, player-activated buttons 160, player tracking panel 136, bill/voucher acceptor 180 and one or more speakers 190. Cabinet housing 120 houses a processor, circuitry, and software (not shown) for receiving signals from the player-activated buttons 160, configuring and operating the games, and transmitting signals to the respective displays and speakers. Gaming machine 100 may be, by way of example and not by limitation, a slot machine running the Alpha OS gaming software platform by Bally Technologies, Inc.

In accordance with one or more embodiments of the invention, gaming machine 100 may be pre-configured with multiple sets of operating parameters or attributes, each separate configuration associated with a desired start and end time for that configuration. A slot manager or other authorized personnel are able to preset these settings during gaming machine configuration so that the changes occur repeatedly and automatically at times in the future without the need for an operator to be physically present. A scheduler associated with a real-time clock incorporated into the operating software of gaming machine 100 automatically switches the current operating configuration of the gaming machine from one configuration to another based on the specified start and end weekdays and times of each configuration. In one embodiment, a specific date may be used, for example, December 25^{th}. In one or more embodiments, a default configuration may be used in periods not specifically allocated to one of the predefined configurations. In accordance with one or more embodiments, the multiple configurations may be specified by an operator at the gaming machine, as will be described further below. In other embodiments, the configurations may be defined remotely and downloaded to the gaming machine from a remote server by way of a network. An example of configuring a gaming machine by way of a network may be found in U.S. patent application Ser. No. 11/530,880, entitled “System for Configuration,” filed on Sep. 11, 2006 and hereby incorporated by reference in its entirety for all purposes.

In accordance with one or more embodiments, various game, denomination, and configuration mixes may be defined. The scheduler allows the configuration of attributes related to pay table configuration including, but not limited to, enabling/disabling pay percentage/denomination pairs (e.g., 92%/1¢, 88%/2¢). In addition, the scheduler may allow the setting of the number of pay lines and the maximum wager per line or maximum total wager per game. For poker, keno, blackjack and lotto games, the scheduler may allow the setting of the number of cards or hands, the maximum wager per game, card or hand. In accordance with one or more embodiments, the scheduler may allow the enabling or disabling of one or more progressives associated with one or more game titles or type of game, and may allow definition of the reset value and incrementation rate for each of the progressives. In still other embodiments, the scheduler may allow for the enablement/disablement of tournament pay tables and separate associated tournament metering. In accordance with another embodiment, the scheduler may allow for the configuration of attributes related to denomination including, but not limited to, the display or suppression of various credit denominations. Alternately, unavailable denominations may be shrouded from the player, for example, by shading, to denote they are not currently available for a particular game.

In accordance with still other embodiments, parameters or attributes such as, but not limited to, a number of free games awarded, a range of bonus multipliers awarded, a range of bonus awards awarded, a number of selections made by a player during a feature game play and the number and kind of feature games available may be separately configurable in each configuration set. For example, a game may offer a double-up feature game with a number of settings such as feature game enable or disable, style of presentation from a list of common styles such as red/black choice, beat the dealer card or a roulette-style game. In one embodiment, it may be possible to set the return percentage of the double-up game, such as 110% return over a certain time period, such as two hours.

Table 1, below, provides an example of a set of configuration data that may be downloaded from memory stored on the gaming machine. In the sample data various examples of multi-game mixes based on daytime, night time/weekend, high denomination, and tournament criteria in which some of the above parameters are altered according to the mix. Other mix themes/titles may be created according to their intended use, for example, holiday or graveyard shift mixes might be created.

By way of further example, in Table 1, a slot game entitled American Original has a return percentage of 88%, is available for play in 1- and 2-cent denominations and offers 50 pay lines with a 250 credit maximum wager in a daytime mix. In an evening/weekend mix, a slot game with the same title is available with an increased return percentage of 90%, play denominations of 5, 10 and 25 cents with up to 25 pay lines and a maximum wager of 125 credits. American Original is not available in the example high-denomination and tournament mixes. As shown, in one or more embodiments, entire classes of games may be omitted from a mix. For example, the mixes in Table 1 do not offer keno in evening/weekend, high denomination or tournament settings. In another example, the tournament mix, which offers only a single slot game, excludes poker, keno and blackjack games.

TABLE 1

| | | | Keno Game | Blackjack Game |
|---|---|---|---|---|
| Mix | Slot Game Titles and | Poker Game Titles | Titles and | Titles and |
| Identifier | Characteristics | and Characteristics | Characteristics | Characteristics |
| Daytime | American Original | Jacks or Better | Standard Keno | Standard |
| Mix | (88%/1¢-2¢/ | (96.15%/25¢/5 max); | (86.72%/25¢/5 max) | Blackjack |
| | 50L/250 max) | Double Double Bonus | Way Keno | (97.28%/25¢-50¢/ |
| | Bonus 7s Grand | (95.71%/25¢/5 max); | (92%/5¢/7 max) | 10 max) |
| | (88%/1¢-2¢/ | Joker Poker | Triple Trouble | |
| | 20L/60 max/ | (94.00%/25¢/5 max); | Keno | |
| | 20,000 credit to | Deuces Wild | (92%/25¢/5 max) | |
| | award) | (96.34%/25¢/5 max); | | |
| | Black &White 7s | Deuces Wild Bonus | | |
| | Two Way Frenzy | (96.22%/25¢/5 max) | | |
| | (88%/1¢-2¢/ | | | |
| | 50L/250 max) | | | |
| | Winning Times | | | |
| | (88%/1¢-2¢/ | | | |
| | 50L/250 max) | | | |
| Evening/ | American Original | Jacks or Better | Standard | Standard |
| Weekend | (90%/5¢-10¢-25¢/ | (97.30%/$1/5 max) | N/A | Blackjack |
| Mix | 25L/125 max) | Double Double Bonus | Way Keno | (97.28%/$1/10 |
| | Bonus 7s Grand | (96.79%/$1/5 max) | N/A | max) |
| | (90%/5¢-10¢-25¢/ | Joker Poker | Triple Trouble | |
| | 20L/60 max/20,000 | (96.74%/$1/5 max) | Keno | |
| | credit to award) | Deuces Wild | N/A | |
| | Black &White 7s | (97.06%/$1/5 max) | | |
| | Two Way Frenzy | Deuces Wild Bonus | | |
| | Gambler | (97.36%/$1/5 max) | | |
| | (90%/5¢-10¢-25¢/ | | | |
| | 50L/250 max) | | | |
| | Winning Times | | | |
| | (90%/5¢-10¢-25¢/ | | | |
| | 25L/125 max) | | | |
| High | American Original | Jacks or Better | Standard Keno | Standard |
| Denom. | N/A | (98.45%/$2-$5-$10/ | N/A | Blackjack |
| Mix | Bonus 7s Grand | 5 max) | Way Keno | (97.28%/$2-$5-$10/ |
| | (94%/$1/9L/27 max/100,000 | Double Double Bonus | N/A | 5 max) |
| | credit top | (98.98%/$2-$5-$10/ | Triple Trouble | |
| | award) | 5 max) | Keno | |
| | Black &White 7s | Joker Poker | N/A | |
| | Two Way Frenzy | (98.44%/$2-$5-$10/ | | |
| | Gambler | 5 max) | | |
| | N/A | Deuces Wild | | |
| | Winning Times | (98.00%/$2-$5-$10/ | | |
| | (94%/$1/5L/25 max) | 5 max) | | |
| | 24 Karat | Deuces Wild Bonus | | |
| | (94%/$1/5L/25 max) | (98.28%/$2-$5-$10/ | | |
| | | 5 max) | | |
| Tournament | 24 Karat Tournament | | | |
| Mix | (2000%/$2/5L/5 max) | | | |

In one or more embodiments, the scheduler may allow the configuration of attributes related to an individual game's player interface such as game graphics, game symbols, game messages, including selection of one or more languages, a game menu icon, a set of top screen graphics (“virtual glass”) or other indicia outside of the game screen such as an icon that informs an attendant or player of the current game mode.

In other embodiments, in addition to configuration of individual game attributes, the scheduler may allow configuration of attributes related to the overall gaming machine, such as its game selection screen. For example, a gaming machine operator may elect to display only game icons for games currently available for play according to the current mix or to partially shroud or mask the choices for games installed but not currently available for play.

In still other embodiments, the scheduler may allow for configuration of attributes related to when the change from one machine configuration or mix to another is triggered. Changes may be set to trigger, for example, at a certain time of day, on a certain day of the week, according to a calendar-based date, or based on a direct request by an operator or gaming machine attendant. In one or more embodiments, triggered configuration changes may be set to actually occur when the gaming machine is in a particular state. For example, a triggered configuration change may occur upon the start of an idle/attract mode, upon a cash-out or other situation in which the credit meter is zeroed; upon entering the gaming machine's main menu; or upon a game or denomination change by the player.

Cabinet housing 120 is a self-standing unit that is generally rectangular in shape and may be manufactured with reinforced steel or other rigid materials which are resistant to tampering and vandalism. Any shaped cabinet may be implemented with any embodiment of reconfigurable gaming machine 100 so long as it provides access to a player for playing a game. For example, cabinet 120 may comprise a slant-top, bar-top, cinema or table-top style cabinet. The operation of gaming machine 100 is described more fully below.

The plurality of player-activated buttons 160 may be used for various functions such as, but not limited to, selecting a wager denomination, selecting a game to be played, selecting a wager amount per game, initiating a game, or cashing out money from gaming machine 100. Buttons 160 function as input mechanisms and may include mechanical buttons, electromechanical buttons or touch screen buttons. Optionally, a handle (not shown) may be rotated by a player to initiate a game.

In other embodiments, buttons 160 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 120 may optionally include top box 150 which contains “top glass” 152 comprising advertising or payout information related to the game or games available on gaming machine 100. Player tracking panel 136 includes player tracking card reader 134 and player tracking display 132. Voucher printer 130 may be integrated into player tracking panel 136 or installed elsewhere in cabinet housing 120 or top box 150.

Game display 140 presents a game of chance wherein a player receives one or more outcomes from a set of potential outcomes. For example, in various aspects of the invention, gaming machine 100 may present a video or mechanical reel slot machine, a video keno game, a lottery game, a bingo game, a Class II bingo game, a roulette game, a craps game, a blackjack game, a mechanical or video representation of a wheel game or the like.

In the example of FIG. 1, game display 140 includes a set of five electromechanical reels, however, other mechanical or video/mechanical embodiments may include game displays such as one or more video displays, wheels, or dice as required to present the game to the player. In video/mechanical or pure video embodiments, game display 140 is, typically, a CRT or a flat-panel display in the form of, but not limited to, liquid crystal, plasma, electroluminescent, vacuum fluorescent, field emission, or any other type of panel display known or developed in the art. Game display 140 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide.

Additionally, game display 140 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference.

In one or more embodiments of the invention, game display 140 may also present information such as, but not limited to, player information, advertisements and casino promotions, graphic displays, news and sports updates, or even offer an alternate game. This information may be generated through a host computer networked with gaming machine 100 on its own initiative or it may be obtained by request of the player using either one or more of the plurality of player-activated buttons 160; the game display itself, if game display 140 comprises a touch screen or similar technology; buttons (not shown) mounted about game display 140 which may permit selections such as those found on an ATM machine, where legends on the screen are associated with respective selecting buttons; or any player input device that offers the required functionality.

Cabinet housing 120 incorporates a single game display 140. However, in alternate embodiments, cabinet housing 120 or top box 150 may house one or more additional displays 153 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

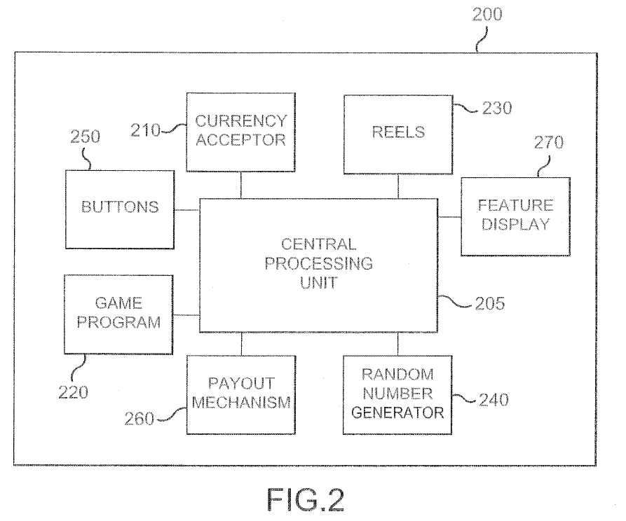

In accordance with one embodiment of the present invention, FIG. 2 is a block diagram showing an example interconnection 200 of physical and logical components of gaming machine 100. Currency acceptor 210 is typically connected to a conventional central processing unit (“CPU”) 205, such as an Intel Pentium microprocessor mounted on a gaming motherboard, by a serial connection such as RS-232 or USB. The gaming motherboard may be mounted with other conventional components, such as are found on conventional personal computer motherboards, and loaded with a gaming machine operating system (OS), such as an Alpha OS installed within a Bally S9000, M9000, CineVision™ or CineReels™ slot machine. CPU 205 executes one or more game programs 220 that cause reels 230 to display one or more games.

When a player has inserted a form of currency such as, for example and without limitation, paper currency, coins or tokens, cashless tickets or vouchers, electronic funds transfers or the like into currency acceptor 210, a signal is sent to CPU 205 which, in turn, assigns an appropriate number of credits for play. The player may further control the operation of the gaming machine, for example, to select the amount to wager via electromechanical or touch screen buttons 250. The game starts in response to the player pushing one of buttons 250 or an alternate start mechanism such as a handle or touch screen icon (not shown). Random number generator 240 responds to instructions from CPU 205 to provide a display of randomly selected indicia on reels 230. In some embodiments, random generator 240 may be physically separate from gaming machine 200; for example, it may be part of a central determination host system (not shown) which provides random game outcomes to CPU 205. Thereafter, the player may or may not interact with the game through electromechanical or touch screen buttons 250 to change the displayed indicia. Finally, CPU 205 under control of the game program 220 compares the final display of indicia to a pay table. The set of possible game outcomes may include a subset of outcomes related to the triggering of a feature game. In the event the displayed outcome is a member of this subset, CPU 205, under control of game program 220, may cause feature game play to be presented on feature display 270.

In one embodiment, reels 230 are electromechanical reels. Game program 220 includes reel spinning firmware to provide proper signals for driving multiple stepper motors (not shown), which, in turn, spin the reels 230. Preferably, the motors are driven using a “full step” excitation sequence in which a single motor step is preformed by changing the excitation on one of the two-phase inputs in a specified sequence. The sequence determines whether the direction implemented is forward or reverse. The reel drive pulse trains go through three distinct stages: acceleration, steady state, and deceleration. During acceleration, reels 230 are driven with a pulse frequency that is less than the maximum “start/stop” frequency. Typically, if a motor is attempted to be started with a high frequency pulse, the motor loses synchronization and slips. Therefore, preferably the drive frequency is incrementally increased until the steady state drive frequency is reached. At steady state, reels 230 are driven for a specified number of steps at the maximum drive frequency before going to the deceleration phase. During deceleration, the process is reversed and the drive frequency decreased until the stopping frequency is reached. Preferably, this procedure helps to prevent reels 230 from slipping past the proper stop position on deceleration. Finally, at the stopping point, the motor excitation signals are held constant.

In one embodiment, the primary game reels are not used for the feature play; instead, a wheel or other feature display 270 is used to present the feature game outcomes. The feature display may be an electromechanical device, may present the feature on a video display or both.

Predetermined payout amounts for certain outcomes, including feature game outcomes, are stored as part of one or more game programs 220. Such payout amounts are, in response to instructions from CPU 205, provided to the player in the form of coins, credits or currency via payout mechanism 260, which may be one or more of a credit meter, a coin hopper, a voucher printer, an electronic funds transfer protocol or any other payout means known or developed in the art.

In various embodiments of gaming machine 100, game program(s) 220 is/are stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 100 are stored in the same or a separate memory device (not shown). Some or all of game programs 220 and associated data, including configuration data, may be loaded from one memory device into another, for example, from flash memory to random access memory (RAM).

In accordance with one embodiment of the invention, scheduler 280 is operatively coupled to CPU 205. Scheduler 280 allows an operator to pre-set one or more gaming machine configuration changes according to time-based criteria. Specifically, configuration changes related to game themes, percentages, wagers, pay tables, and denominations of game programs 220 can be predefined on a time-based schedule. A slot manager or other authorized person is able to configure these settings during gaming machine configuration so that the changes occur repeatedly and automatically at times in the future without the need for an operator to be physically present.

For example, a slot manager may want to eliminate use of all penny and two-cent denominations from a gaming machine every Friday evening at 5 PM. and then add them back in on Monday morning at 9 AM. In operation, the gaming machine would affect the desired changes in configuration at approximately the scheduled times. In accordance with one or more embodiments, actual reconfiguration may be delayed because a gaming machine was unavailable for reconfiguration because it was in use by a player, down for maintenance, etc. In these cases, reconfiguration takes place as close to the pre-selected time as possible.

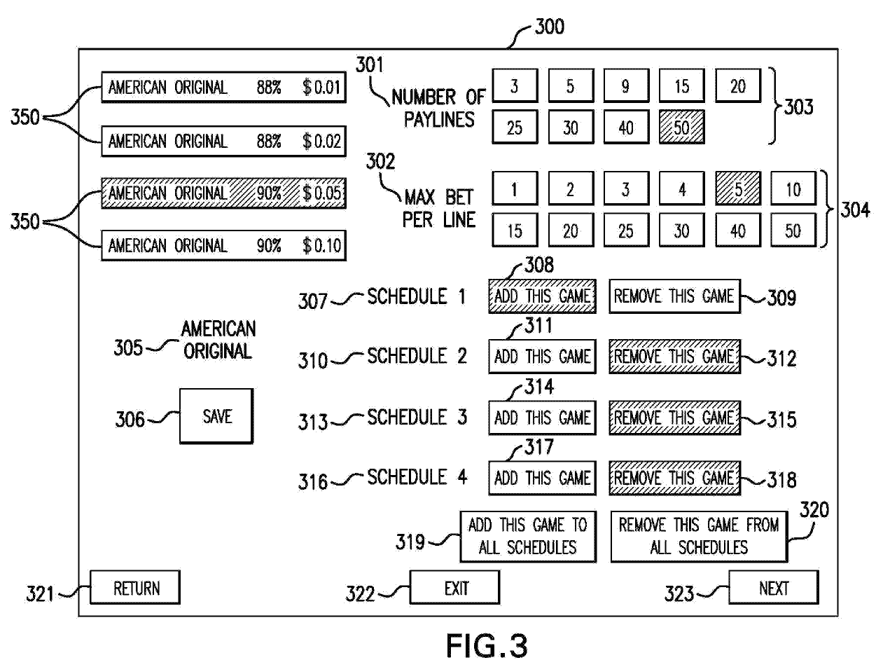

In accordance with one or more embodiments of the invention, FIG. 3 illustrates an example game configuration screen that may be generated through programming of a GameMaker Scheduler module as part of the game operating system, such as a Bally Alpha operating system, as executed by processor 205 and accessing the configuration data stored on the gaming machine, such as on an EEPROM, flash memory, or harddrive connected to the gaming machine motherboard. Alternatively, the GameMaker Scheduler may be implemented as part of a user control interface unit, which may be incorporated as part of a player interface unit having its own processor board and memory, such as a Bally iView. In each case, the game configuration screen may be programmed to display upon a display, such as a main game display or player interface display, a port-connected operator unit such as a tablet or laptop computer connected to a USB or infrared port on the selected gaming machine or through a wireless connection, or, a remote network connected operator station such as a commercially available Bally Control Panel server station which may be connected to slot or casino management server system (SMS or CMS) such as a commercially available Bally SDS or ACSC SMS or CMS, after a user or users has/have entered authorized user identifications and passwords. In the case of the remotely connected operator station, an editing module may be utilized to modify or select various of the configurations and/or attributes for a single gaming machine or a selected subset of gaming machines connected to a network. According to the programming, one or two users may be required to enter their identifications, such as by inserting a user card into a card reader or keying (typing) in a username, and passwords, prior to being granted access to the configuration screen. The configuration screen may be programmed to display on a touch sensitive screen where the various options may be selected by touching the locations where the option field appears. Alternatively, a user may use a keypad to key in the desired option. In the case of connecting a device either directly by cable, infrared, or remotely to the gaming machine and editing the game and/or configuration information in memory, the editing data may be encrypted prior to transmission and decrypted by the gaming machine in order to provide an additional level of security. A processor on board the gaming machine may also perform verification and authentication processes to confirm authenticity and correctness of a received edit.

The configuration data may be installed on each gaming machine prior to or after installation at a gaming establishment. The configuration data may include various subsets that may be applicable to all of the gaming machines installed at a given gaming establishment. Alternatively, various configuration subsets may only be applicable to subsets of the gaming machines in which case the configuration software may include coding for each processor to determine which if any of the subsets are applicable to their respective gaming machines at times designated for changing configurations and/or operating attributes. When displayed as in FIG. 3, the available configurations or attributes may be selectively enabled depending upon whether that are applicable to the selected gaming machine or machines. For example, the American Original gaming theme may be applicable to one or more American Original themed gaming machines but may not be applicable to a Blazing Sevens themed gaming machine. In one or more embodiments, one or more gaming machines may be configured to change gaming themes from one gaming theme to another, such as from a Blazing Sevens gaming theme to an American Original gaming theme. In such cases the top glass display may either be generically themed or may be programmable.

In one or more embodiments where the configuration data memory is installed by the gaming machine manufacturer or other third party, additional gaming themes and feature sets may be loaded by an operator subject to one or more licenses which may be obtained by the operator for a fee, either in advance or at the time the operator chooses to load the licensed gaming theme and/or feature. In such case, an operator may purchase a license for a pre-determined number of gaming machines for a given gaming theme or feature. The licensor could provide a license key to the operator and the number of copies utilized by an operator may be controlled by the licensor providing a key which may be utilized only a set number of times before it will either expire or transmit a signal to the licensee and/or licensor that an additional license will be required for additional copies of the theme and/or feature. One way to maintain an accounting of the number of instances may be for each gaming machine installing a particular gaming theme and/or feature would be for the configuration code to cause a signal to be transmitted to a server that stores information such as gaming machine identification number, licensed gaming theme and/or feature, and date of loading onto the gaming machine for operation, all of which may be transmitted by the gaming machine at the time of re-configuration of the licensed gaming theme and/or feature. The license server can maintain a license count for each licensed gaming theme and/or feature in its memory and database software can be used to generate license audit reports periodically or on demand. The licensee and licensor may thereby maintain audible data and spreadsheets from which to identify the numbers of licenses required. The license server may retain the number of authorized license instances and be programmed to signal the operator/licensee and/or licensor when the number of instances has either reached the operator's licensed maximum or may be programmed to signal when the number of instances is within a pre-determined number of the authorized licensed limit enabling an operator to obtain additional licensing without hindering operations. In one or more embodiments, the gaming machine may transmit a signal providing the gaming machine and configuration information so that a licensor's server may maintain a count directly and thereby be able to either bill in advance and track the number of instances of a licensed gaming theme and/or feature or maintain a count and bill an operator/licensee on a pay as you go basis where the licensor simply may send a bill for each number of installed instances on a regular billing basis, such as monthly. In one or more embodiments, a hand-shake system may be implemented whereby a gaming machine or operator may send a signal to a licensor requesting the use of a gaming theme and/or feature and the gaming machine configuration software may require receipt of a signal from the licensor or operator providing an access key or authorization signal prior to the requested gaming theme and/or feature being enabled on the gaming machine. Each gaming machine may have a specific authorization key required for enabling various gaming themes and/or features; alternatively, a non-gaming machine specific authorization key may be utilized along with some form of audit trail as discussed above. In the case of gaming machine specific key, the gaming machine's configuration software may include a comparison/verification to identify that a submitted authorization key is valid for the specific gaming machine. An example of a license management system and method is disclosed in U.S. Provisional Patent Application 61/029,612, entitled “License Management System and Method,” filed Feb. 19, 2008 and hereby incorporated by reference in its entirety for all purposes.

An operator may select attributes related to a game theme 305 installed in the gaming machine including, but not limited to, the denomination and percentage by way of buttons 350, the number of pay lines available for play 301 by way of buttons 303 and the maximum wager per line 302 by way of buttons 304. Other settings (not shown) may also be available, such as, but not limited to, a number of free games awarded, a range of bonus multipliers awarded, a range of bonus awards awarded, the number of selections a player may make in a bonus feature and the number and kind of bonus features available. Additionally, in one or more embodiments, a double-up feature may have reconfigurable attributes such as feature enable or disable; double-up game type such as red/black, beat the dealer, or a roulette-style game; return-to-player percentages (e.g., 110% return over the next 2 hours) and the like that may be assigned to one or more of the schedules 307, 310, 313 and 316.

The operator may assign a selected mix of percentage, denomination, number of pay lines and maximum bet per line to one or more of four schedules 307, 310, 313 and 316 by way of buttons 308, 311, 314 and 317. Buttons 309, 312, 315 and 318 allow for the removal of a particular option mix from schedules 307, 310, 313 and 316, respectively. Buttons 318 and 320 provide “shortcuts,” allowing the operator to easily add or remove an option mix from all four schedules with a single button press. Button 306 allows the operator to save his current settings to semi-permanent storage such as battery-backed memory, EEPROM, flash memory, a hard disk or the like. RETURN button 321, EXIT button 322 and NEXT button 323 allow the operator to navigate to other screens provided by the gaming machine.

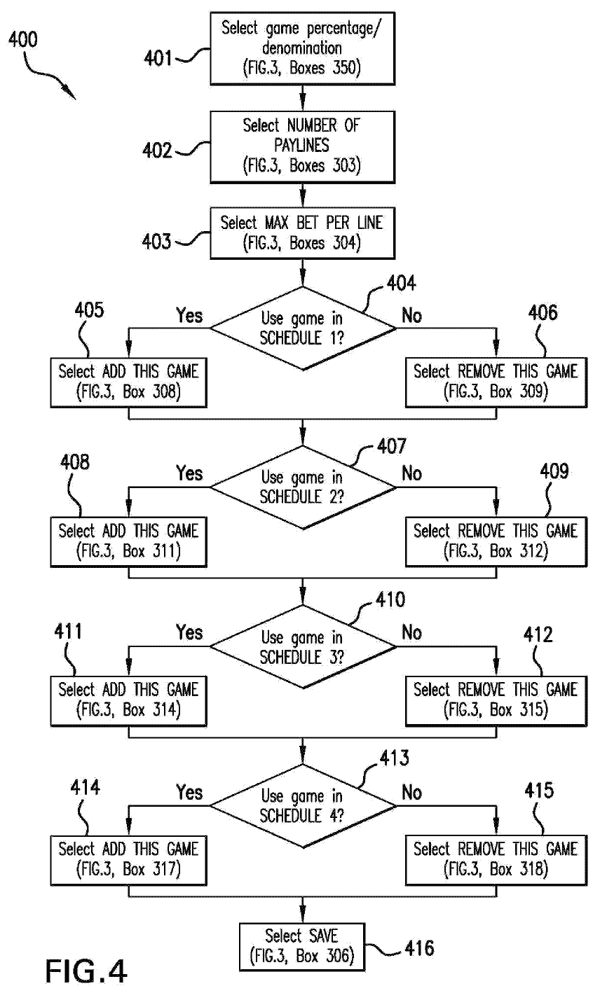

A logical flow diagram generally depicting the steps associated with an example method 400 for carrying out a game configuration with reconfigurable parameters in accordance with one or more aspects of the invention is presented in FIG. 4. The order of actions as shown in FIG. 4 is only illustrative, and should not be considered limiting. For example, the order of the actions may be changed, additional steps may be added or some steps may be removed without deviating from the scope and spirit of the invention.

At Box 401, an operator selects a desired game percentage/denomination by pressing one of a set of game percentage/denomination buttons (FIG. 3, Boxes 350). The operator then selects a desired number of pay lines by pressing one of a set of associated buttons (FIG. 3, Boxes 303) at Box 402. The operator selects a desired maximum bet per line by pressing the associated button (FIG. 3, Boxes 304) at Box 403.

Once the operator has selected a desired mix of game percentage/denomination, number of pay lines and maximum bet per line, he may add the mix to one or more of four schedules. At Decision 404, the operator determines if he wishes to add the currently selected configuration mix to Schedule 1. To add the selected game configuration to Schedule 1, the operators presses the ADD THIS GAME button (FIG. 3, Box 308) for Schedule 1 at Box 405. Otherwise, the operator presses the REMOVE THIS GAME button (FIG. 3, Box 309) for Schedule 1 at Box 406.

At Decision 407, the operator determines if he wishes to add the currently selected configuration mix to Schedule 2. To add the selected game configuration to Schedule 2, the operators presses the ADD THIS GAME button (FIG. 3, Box 311) for Schedule 2 at Box 408. Otherwise, the operator presses the REMOVE THIS GAME button (FIG. 3, Box 312) for Schedule 2 at Box 409.

At Decision 410, the operator determines if he wishes to add the currently selected configuration mix to Schedule 3. To add the selected game configuration to Schedule 3, the operators presses the ADD THIS GAME button (FIG. 3, Box 314) for Schedule 1 at Box 411. Otherwise, the operator presses the REMOVE THIS GAME button (FIG. 3, Box 315) for Schedule 1 at Box 412.

At Decision 413, the operator determines if he wishes to add the currently selected configuration mix to Schedule 4. To add the selected game configuration to Schedule 4, the operators presses the ADD THIS GAME button (FIG. 3, Box 317) for Schedule 4 at Box 414. Otherwise, the operator presses the REMOVE THIS GAME button (FIG. 3, Box 318) for Schedule 4 at Box 415.

To save the game configuration and associated schedule configuration(s), the operator presses a SAVE button (FIG. 3, Box 306) at Box 416. To add the desired game configuration mix to all schedules, the operator may press an ADD THIS GAME TO ALL SCHEDULES button (FIG. 3, Box 319). Similarly, to remove the selected game configuration mix from all schedules, the operator may press a REMOVE THIS GAME FROM ALL SCHEDULES button (FIG. 3, Box 320).

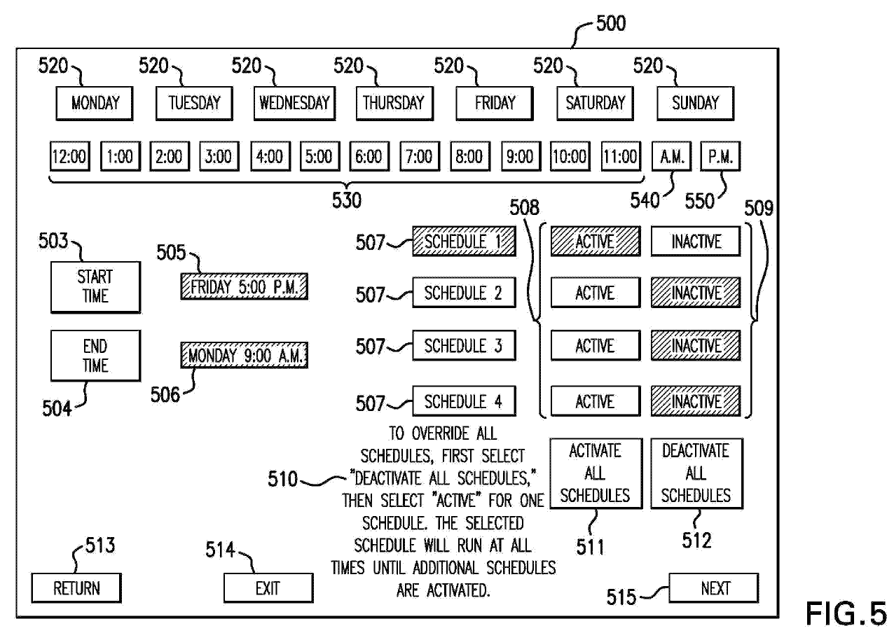

Once the operator has configured one or more games and assigned various parameter mixes to one or more schedules, each schedule must be assigned a start and end time and activated. In accordance with one or more embodiments of the invention, FIG. 5 illustrates an example schedule configuration screen 500 displayed and controlled by a gaming machine.

The operator may select one of four schedules 507 to be modified by pressing the desired SCHEDULE button 507. The selected schedule may be highlighted. In the example, Schedule 1 (507) is highlighted.

The start time for the selected schedule may be defined by pressing START TIME button 103 followed by the desired day of the week button 520, time of day button 530 and A.M. button 540 or P.M. button 550. The defined start time is displayed in window 505. Similarly, the end time for the selected schedule may be defined by pressing END TIME button 504 followed by the desired day of the week button 520, time of day button 530 and A.M. button 540 or P.M. button 550. The defined end time for the selected schedule is displayed in window 506. The operator may configure all four schedules by way of these controls.

Once the times for each desired schedule 507 have been defined, the operator may activate all configured scheduled by pressing the ACTIVATE ALL SCHEDULES button 511 or may individually press each ACTIVE button 508 associated with the schedules he wishes to activate. To deactivate (override) all configured schedules, the operator may press the DEACTIVATE ALL SCHEDULES button 512. In one or more embodiments, the operator must then press at least one ACTIVE button 508. The activated schedule will define the operating characteristics of the gaming machine at all times until additional schedules are activated

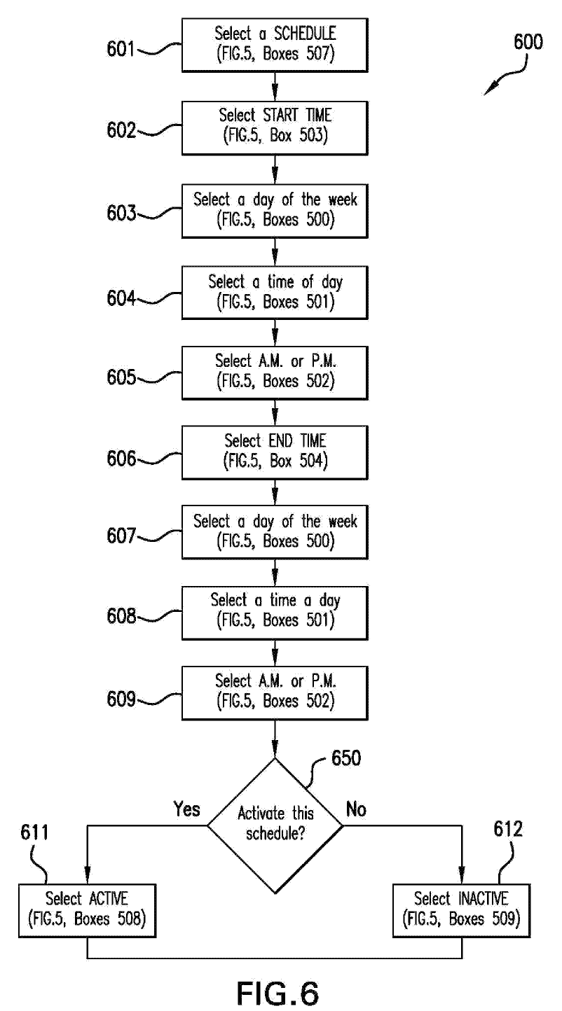

A logical flow diagram generally depicting the steps associated with an example method 600 for carrying out a schedule configuration in accordance with one or more aspects of the invention is presented in FIG. 6. The order of actions as shown in FIG. 6 is only illustrative, and should not be considered limiting. For example, the order of the actions may be changed, additional steps may be added or some steps may be removed without deviating from the scope and spirit of the invention.

Once the operator has configured one or more games and assigned various parameter mixes to one or more schedules, each schedule must be assigned a start and end time and activated.

At Box 601, a schedule to be modified is selected. In one embodiment, this is accomplished by pressing one of a set of SCHEDULE buttons.

At Box 602, a START TIME button is pressed (ex.:FIG. 5, 503), then a day of the week is selected at Box 603 by pressing one of a set of weekday buttons (ex.: FIG. 5, 520).

A time of day at which the selected schedule is to start is selected by pressing the hour button (ex.: FIG. 5, 530) associated with the desired time of day at Box 604, followed by a selection of A.M. or P.M. (ex.: FIG. 5, 540-550) at Box 605. The selected start time is displayed.

At Box 606, an END TIME button is pressed (ex.:FIG. 5, 504), then a day of the week is selected at Box 607 by pressing one of a set of weekday buttons (ex.: FIG. 5, 520).

A time of day at which the selected schedule is to end is selected by pressing the hour button (ex.: FIG. 5, 530) associated with the desired time of day at Box 608, followed by a selection of A.M. or P.M. (ex.: FIG. 5, 540-550) at Box 609. The selected end time is displayed. A decision to activate the configured schedule is made at Decision 610. If activation is desired, an ACTIVE button (ex.: FIG. 5, 508) associated with the schedule is pressed. If activation at Decision 610 is not currently desired, an INACTIVE button (ex. FIG. 5, 509) is pressed. The time settings and active/inactive status of the currently selected schedule are saved when either an ACTIVE or an INACTIVE button is pressed.

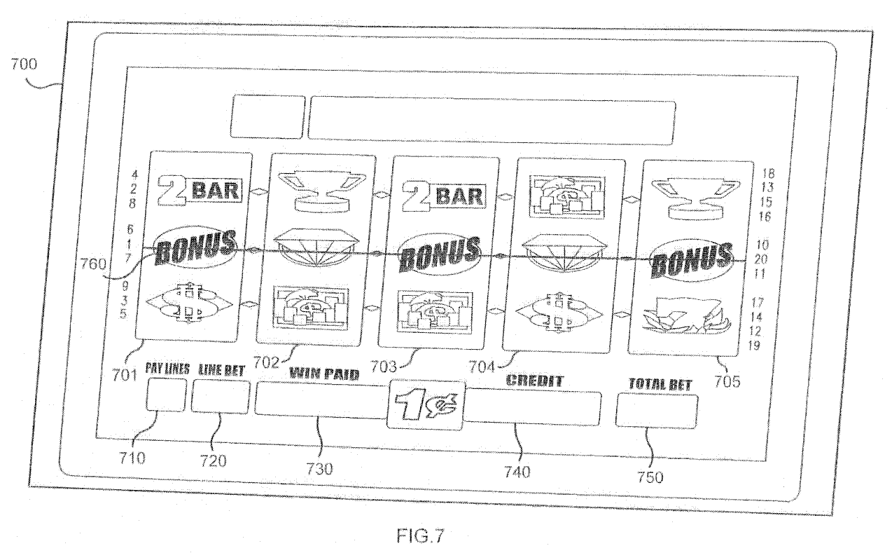

An example game in accordance with one or more aspects of the invention is shown in FIG. 7. Referring to FIG. 7, game 700 is implemented using five spinning reels 701-705. Each of 30 pay line patterns (not shown) passes through one indicium on each of the five reels. For example, the first pay line 760 extends horizontally through the center position of each of the five reels 701-705. The number of pay lines and their patterns are by way of example only and may vary. The player selects the number of played pay lines and the number of credits or coins wagered on each line using touch screen controls or gaming device control buttons. The player's selections are displayed on PAY LINES meter 710, LINE BET meter 720 and TOTAL BET meter 730 located adjacent to the reels. WIN PAID meter 740 and CREDIT meter 750 provide the player with information about the amount paid by the last game played and the total number of credits available for play. The player may collect the balance of his credits by pressing a COLLECT button (not shown).

The player initiates game play by pressing a SPIN button (not shown). In some embodiments, the player may simultaneously select all pay lines at the maximum number of coins or credits allowed per line by pressing a MAX BET button. Buttons (see FIG. 1, 160) on gaming machine 100 (FIG. 1) or touch screen buttons (not shown) may be used to perform the actions described here without deviating from the scope of the invention. Reels 701-705 are made to spin and stop in predetermined stop positions. A determination is then made whether the stop positions of the reels resulted in a winning game outcome.

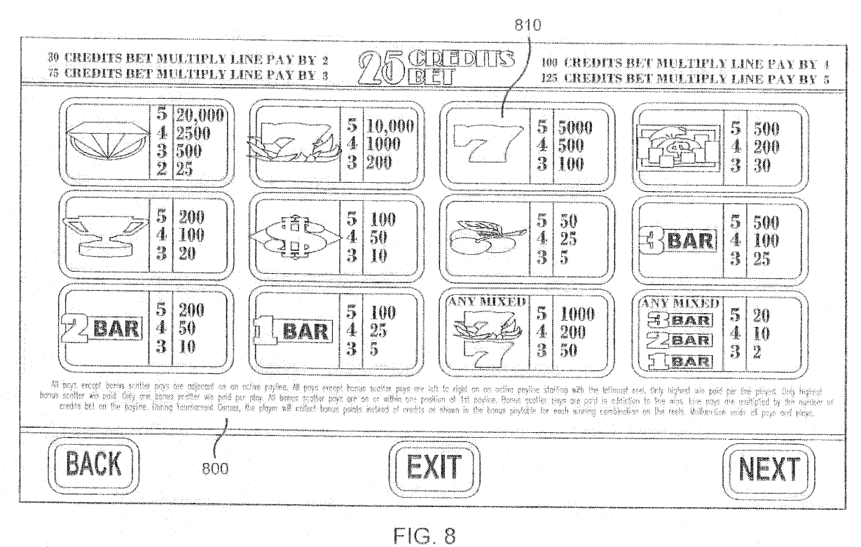

In accordance with one embodiment, part of an example pay table 800 is shown in FIG. 8. The pay table may be accessible through a HELP/PAYS or similar button. In alternate embodiments, the pay table may be presented on a second video or printed display attached to the gaming device (i.e. display 153 or “pay glass” 152, FIG. 1). A winning combination, for example, could be three or more symbols adjacent to one another on an active pay line. For each winning combination, the game device awards the player the award in the pay table, adjusted as necessary based on the number of credits wagered on the pay line on which the win occurred. For example, three RED 7 symbols 710 adjacent to one another from left-to-right on an active pay line would pay 100 times the player's wager. In some embodiments, video representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to be result in pay amounts in excess of the normal winning combination by way of multiplication or addition, for example, a wild doubler symbol may be used.

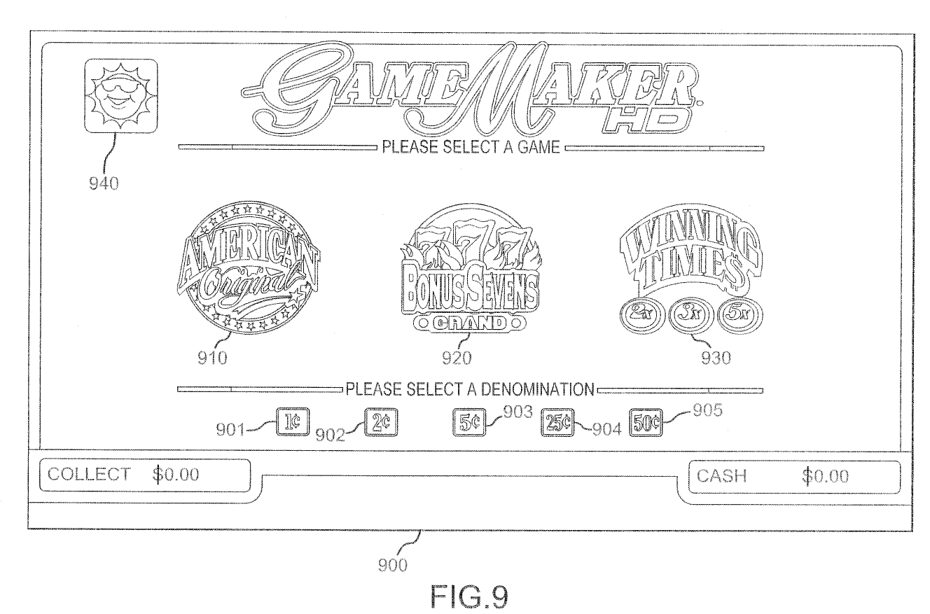

In accordance with one or more embodiments of the invention, a gaming machine menu 900 presents one or more games 910, 920 and 930 for selection by a player. Additional, the player may choose from one of a set of denominations 901, 902, 903, 904 and 905. The specific games and denominations presented are the result of automatic selection or enablement by a scheduler of one of a set of preset configurations. The scheduler selects a current configuration based on start and end time parameters associated with each of the set of preset configurations. In accordance with one or more embodiments, an icon 940 representing the current configuration is presented on the gaming machine menu. In the example of FIG. 9, the icon represents a sun, indicating that a configuration associated with daytime operation is enabled. In other embodiments, no icon is displayed.

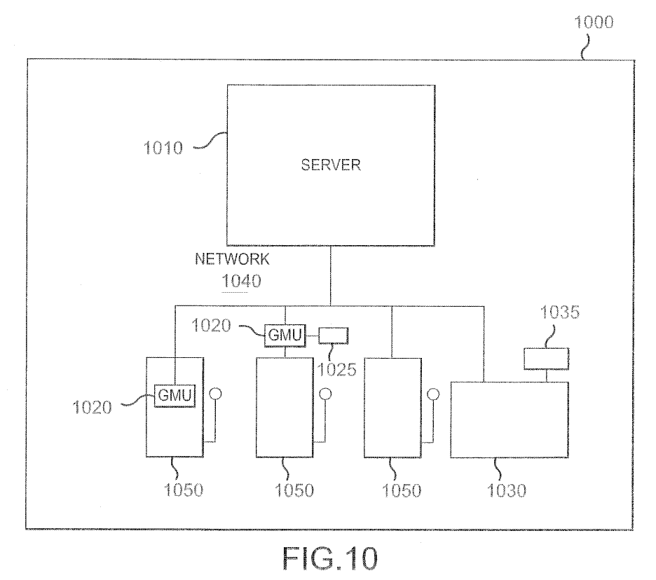

Referring to FIG. 10, in accordance with one or more aspects of the invention, a networked gaming system 1000 includes server 1010, gaming machines 1050, and network 1040 connecting gaming machines 1050 to server 1010. Additionally, gaming machine 1050 are shown connected to group gaming controller 1030 and progressive controller 1060. One or more of gaming machines 1050 may be reconfigurable in accordance with one or more aspects of the invention. Server 1010 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 1010 may be configured as a single “logical” server that comprises multiple physical servers. Gaming machines 1050 operate similar to conventional peripheral networked terminals. Gaming machines 1050 have a player interface such as a display, a card reader, and selection buttons through which gaming machines 1050 interact with a player playing a group game in accordance with various embodiments of the invention. The player interface is used for making choices such as the amount of a bet or the number of lines to bet. Gaming machines 1050 also provide information to server 1010 concerning activity on gaming machines 1050 and provide a communication portal for players with server 1010. For example, the player interface may be used for selecting different server-related menu options such as, but not limited to, transferring a specified number of credits from a player account onto the credit meter of the gaming machine, or for transferring credits from the gaming machine to a central player account. As described above, the configuration settings may be edited with respect to each of the gaming machines from server 1010 which may include software implemented to provide the functionality for editing as described in detail above with respect to individual gaming machines and license tracking and/or audit functionality.

In various embodiments, any of the gaming machines 1050 may be a mechanical reel spinning slot machine, video slot machine, video poker machine, keno machine, video blackjack machine, or a gaming machine offering one or more of the above described primary games including a group play game. Alternately, gaming machines 1050 may provide one or more games as one of a set of multiple primary games selected for play by a random number generator. Networking components (not shown) facilitate communications across network 1040 between the system server 1010 and game management units 1020 and/or gaming display control computers 1030 that control displays for carousels of gaming machines. Game management units (GMU's) 1020 connect gaming machines to networking components and may be installed in the gaming machine cabinet or external to the gaming machine. The function of the GMU is similar to the function of a network interface card connected to a desktop personal computer (PC) and it may contain tracking software which provides notification to the casino of certain events on a gaming machine 1050, including wins. Depending upon the casino management system, payouts on large wins at gaming machines 1050 may be made directly to a player account managed by the host computer; in which case, the player is notified by way of the GMU at gaming machine 1050 that the player's account has been credited.

Some GMU's have much greater capability and can perform such tasks as presenting and playing a game using a display 1025 operatively connected to GMU 1020. In one embodiment, GMU 1020 is a separate component located outside the gaming machine. Alternatively, in another embodiment, the GMU 1020 is located within the gaming machine. Optionally, in an alternative embodiment, one or more gaming machines 1050 connect directly to the network and are not connected to a GMU 1020. Displays related to group games played on gaming machines 1050 or GMU displays 1025 may also be presented on gaming display 1035 by group gaming controller 1030. Group gaming controller is also shown connected to network 1040, through which it may be capable of receiving reconfigured displays for presentation on display 1035. A gaming system of the type described above also allows a plurality of games in accordance with the various embodiments of the invention to be linked under the control of server 1010 for cooperative or competitive play in a particular area, carousel, casino or between casinos located in geographically separate areas.

The various embodiments described above are provided by way of illustration only and should not be construed to limit the claimed invention. For example, it may further be appreciated that each of the games could be operated on a remote host computer such that a player initiates play with the host computer over a network via the player interface and each gaming machine operates the respective gaming and video displays in conjunction with the game whose play is controlled by the remote computer.

Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A reconfigurable gaming machine comprising:
a processor;
a memory operatively coupled to the processor, the memory storing one or more games and a set of preset configurations for the gaming machine; and
a scheduler operable by the processor to activate at least one of the set of configurations.

2. The reconfigurable gaming machine of claim 1 further comprising operating software stored in the memory and executed by the processor.

3. The reconfigurable gaming machine of claim 2 wherein the operating software comprises a real-time clock.

4. The reconfigurable gaming machine of claim 3 wherein an activated configuration may include a predefined start time determinable with the real-time clock.

5. The reconfigurable gaming machine of claim 3 wherein an activated configuration may include a predefined end time determinable with the real-time clock.

6. The reconfigurable gaming machine of claim 1 wherein the scheduler is operable to activate one of the games at a first pre-determined time and for a first pre-defined period, and to subsequently activate a second of the games at a second pre-determined time and for a second pre-defined period.

7. The reconfigurable gaming machine of claim 1 wherein the activated one of the set of preset configurations is a default configuration.

8. The reconfigurable gaming machine of claim 7 wherein the default configuration is activated when none of the conditions associated with the others of the set of preset configurations are met.

9. The reconfigurable gaming machine of claim 1 wherein at least one preset configuration further includes an attribute comprising at least one of a game theme, a game denomination, a game pay percentage, a maximum wager amount per game, a maximum wager per pay line, a number of pay lines, a pay table and a number of play lines.

10. The reconfigurable gaming machine of claim 1 wherein at least one preset configuration further includes one or more attributes comprising a set of available feature games.

11. The reconfigurable gaming machine of claim 1 wherein at least one preset configuration further includes a minimum and maximum number of free games.

12. The reconfigurable gaming machine of claim 1 wherein at least one preset configuration further includes a minimum and maximum feature multiplier.

13. The reconfigurable gaming machine of claim 1 wherein at least one preset configuration further includes a minimum and maximum feature award amount.

14. The reconfigurable gaming machine of claim 1 wherein at least one preset configuration further includes a number of selections available to a player during a feature game.

15. The reconfigurable gaming machine of claim 1 further comprising a progressive award associated with at least one of the games.

16. The reconfigurable gaming machine of claim 15 wherein at least one preset configuration further includes an attribute comprising at least one of enabling the progressive award, disabling the progressive award, defining a progressive reset value, and defining an incrementation rate for the progressive award.

17. The reconfigurable gaming machine of claim 1 further comprising a tournament pay table associated with at least one of the games.

18. The reconfigurable gaming machine of claim 17 wherein at least one preset configuration further includes an attribute for enabling or disabling the tournament pay table.

19. The reconfigurable gaming machine of claim 1 wherein at least one preset configuration further includes an attribute comprising at least one of game graphics, game symbols, game messages, game icon and non-game screen indicia.

20. The reconfigurable gaming machine of claim 19 wherein the game messages include a language attribute.

21. The reconfigurable gaming machine of claim 1 wherein the scheduler postpones activation of one of the set of configurations until the gaming machine is available for reconfiguration.

22. The reconfigurable gaming machine of claim 1 wherein the one or more games comprise at least one of a slot machine game, a keno game, a lottery game, a bingo game, a roulette game, a craps game, a blackjack game and a wheel game.

23. The reconfigurable gaming machine of claim 1 further comprising a set of controls operable to select or edit at least one of the configurations.

24. The reconfigurable gaming machine of claim 23 wherein the controls comprise at least one of a touch screen and a key pad.

25. The reconfigurable gaming machine of claim 23 wherein setting of the preset configurations is restricted by way of a user identification or password.

26. The reconfigurable gaming machine of claim 1 wherein the set of preset configurations is downloaded to the gaming machine by way of a network.

27. The reconfigurable gaming machine of claim 1 wherein each preset configuration further comprises an associated displayable icon.
